(19) United States
(12) Patent Application Publication
(10) Pub. No.: US 2013/0042751 A1
(43) Pub. Date: Feb. 21, 2013

(54) Fluid-Actuated Controller Capable of Feedback Regulation

(71) Applicants: Carl Romack, Ann Arbor, MI (US); Dale Moretz, Jackson, MI (US)

(72) Inventors: Carl Romack, Ann Arbor, MI (US); Dale Moretz, Jackson, MI (US)

(21) Appl. No.: 13/264,746

(22) PCT Filed: Apr. 16, 2010
(86) PCT No.: PCT/US2010/031503

§ 371 Date: Jun. 14, 2012

Related U.S. Application Data
(60) Provisional application No. 61/169,794, filed on Apr. 16, 2009.

(51) Int. Cl. F16D 31/02

(52) U.S. Cl. 92/61

(57) ABSTRACT

A fluid-actuated controller, comprising a stationary housing having at least a one discrete internal chamber, each at least one discrete internal chamber being in fluid communication with the stationary housing exterior via an inlet opening; and a rotary actuator mounted in the stationary housing for rotary movement relative thereto, the rotary actuator including at least one piston for effecting rotary movement of the rotary actuator in a first direction. Each such piston is movably disposed in a discrete internal chamber, and each piston is movable within its associated internal chamber in response to a predefined increase in fluid pressure to effect rotary movement of the rotary actuator in the first direction.

### FIELD OF THE INVENTION

The present invention pertains to a fluid-actuated controller for selectively positioning elements, such as fluid ports, contacts, light tubes, etc., that permit energy transfer between each other, and more particularly to such a controller comprising a rotary actuator including at least one piston for effecting rotary movement of the rotary actuator in a first direction and, optionally, at least one piston for effecting rotary movement of the rotary actuator in a second direction in opposition to the first direction.

### BACKGROUND OF THE INVENTION

Myriad apparatus, such as, for instance, rotary valves, electric switches, etc., require a controller for selectively positioning elements, such as fluid ports, contacts, etc., that permit energy transfer between each other. Conventionally, however, such controllers are complicated in construction, comprising multiple individual components. What is needed is a controller that is at once economical to manufacture, characterized by simple construction and operation, and robust.

### SUMMARY OF THE INVENTION

According to the specification, there is disclosed fluid-actuated (e.g., hydraulic fluid, air, oil, water, etc.) controller, comprising a stationary housing having at least one discrete internal chamber, each at least one discrete internal chamber being in fluid communication with the stationary housing exterior via an inlet opening; and a rotary actuator mounted in the stationary housing for rotary movement relative thereto, the rotary actuator including at least one piston for effecting rotary movement of the rotary actuator in a first direction. Each such piston (whether one or more) is movably disposed in a discrete internal chamber, and is movable within its associated internal chamber in response to a predefined increase in fluid pressure to effect rotary movement of the rotary actuator in the first direction.

According to one form of the invention, the stationary housing comprises at least two discrete internal chambers, each internal chamber being in fluid communication with the stationary housing exterior via an inlet opening, with the rotary actuator further including at least one piston for effecting rotary movement of the rotary actuator in a second direction in opposition to the first direction. Each such piston for effecting rotary movement of the rotary actuator in the second direction is movably disposed in a discrete internal chamber, and each piston is movable within its associated internal chamber in response to a predefined increase in fluid pressure to effect rotary movement of the rotary actuator in the second direction.

The rotary actuator may include any combination of pistons for effecting rotary movement of the rotary actuator in the first and, optionally, second directions. Accordingly, it is contemplated that the rotary actuator may be comprised simply of one piston for effecting rotary movement of the rotary actuator in the first direction, or of one piston for effecting rotary movement of the rotary actuator in each of the first and second directions, or of more than one piston for effecting rotary movement of the rotary actuator in either or both of the first and second directions. Thus, in another form of the invention, the housing includes at least three discrete internal chambers, each internal chamber being in fluid communication with the stationary housing exterior via an inlet opening. According to this embodiment, the rotary actuator includes at least two pistons for effecting rotary movement of the rotary actuator in the second direction, each such piston being movably disposed in a discrete internal chamber. Each such piston for effecting rotary movement of the rotary actuator in the second direction is movable within its associated internal chamber in response to a predefined increase in fluid pressure to effect rotary movement of the rotary actuator in the second direction.

And in yet another form, at least two discrete internal chambers are provided in the stationary housing, each internal chamber being in fluid communication with the stationary housing exterior via an inlet opening. Further to this embodiment, the rotary actuator includes at least two pistons for effecting rotary movement of the rotary actuator in the first direction. Each such piston is movably disposed in a discrete internal chamber, and each piston is movable within its associated internal chamber in response to a predefined increase in fluid pressure to effect rotary movement of the rotary actuator in the first direction. Furthermore, the two or more pistons may optionally be combined in a rotary actuator also including one or more pistons for effecting rotary movement of the rotary actuator in the second direction.

Per a further feature, the rotary actuator of any of the foregoing embodiments may be biased, such as, by way of non-limiting example, by a spring, to a default rotational position relative to the stationary housing in the absence of a predefined increase in fluid pressure in any of the one or more internal chambers.

According to a second embodiment, the fluid-actuated controller, comprises a stationary housing having at least a one discrete internal chamber, each at least one discrete internal chamber being in fluid communication with the stationary housing exterior via an inlet opening; and a rotary actuator mounted in the stationary housing for rotary movement relative thereto, the rotary actuator including at least one piston for effecting rotary movement of the rotary actuator in a first direction, each such piston being movably disposed in a discrete internal chamber. Each piston is movable within its associated internal chamber in response to a predefined increase in fluid pressure to effect rotary movement of the rotary actuator in the first direction. The rotary actuator is biased against rotary movement in response to any increase in fluid pressure that is not at least the predefined fluid pressure.

Per one feature, each at least one piston includes a piston face disposed on a first side of the piston which is acted upon by the fluid to effect rotary movement of the rotary actuator, and a second face disposed on a second side of the piston. At least one of the at least one pistons is provided with a fluid passageway for communicating fluid from the first side of the piston to the second side of the piston.

Per a further feature of the present invention, the rotary actuator is biased against rotary movement by a spring.

On one form of the invention, a valve is rotatably coupled to the rotary actuator, the valve being rotatable synchronously with the rotary actuator between a first, opened position of the valve, and a second, closed position of the valve. The valve is moved to the closed position in response to the predefined increase in fluid pressure effecting rotary movement of the rotary actuator, and to the opened position in response to a decrease in fluid pressure from level of the predefined increase.

### BRIEF DESCRIPTION OF THE DRAWINGS

For a better understanding of the present invention and to show more clearly how it may be carried into effect, reference will now be made, by way of example, to the accompanying drawings, which show exemplary embodiments of the present invention, and in which:

FIG. 1 is a perspective view of the assembled controller drive in an exemplary operational environment;

FIG. 2A is a section view of the inventive controller depicting the internal return spring and rotary drive actuator of the exemplary embodiment;

FIG. 2B is a section view of the first and second halves of the stationary housing;

FIG. 3 is an exploded view of the inventive controller;

FIG. 4 is an isometric view of the second half of the stationary housing for the controller;

FIG. 5 is an isometric view of a torsion type return spring;

FIG. 6A is a front view of the rotary actuator;

FIG. 6B is an isometric view of the rotary drive actuator;

FIG. 7A is an isometric view of the outside of a first half of the stationary housing;

FIG. 7B is an isometric view of the inside of the first half of the stationary housing;

FIG. 8 is a cross sectional view of one embodiment of the seal at one of the ports;

FIG. 9 is a cross sectional view of the tabs used to locate and support the internal piston and piston supply bores;

FIG. 10 is a cross sectional view of an external locking tab used to lock the two halves of the stationary housing together;

FIG. 11 is a partially exploded perspective view of an alternative embodiment of the controller of the present invention, with a cover portion removed from the housing;

FIG. 12 is an exploded perspective view of the controller of FIG. 11; and

FIGS. 13a and 13b are simplified diagrams illustrating the operation of the fluid-actuated controller of FIGS. 11 and 12 in an exemplary operating environment.

### DETAILED DESCRIPTION

As required, a detailed description of exemplary embodiments of the present invention are disclosed herein. However, it is to be understood that the disclosed embodiments aremerely exemplary of the invention, which may be embodied in various and alternative forms. The accompanying drawings are not necessarily to scale, and some features may be exaggerated or minimized to show details of particular components. Therefore, specific structural and functional details disclosed herein are not to be interpreted as limiting, but merely as a providing a representative basis for teaching one skilled in the art to variously employ the present invention.

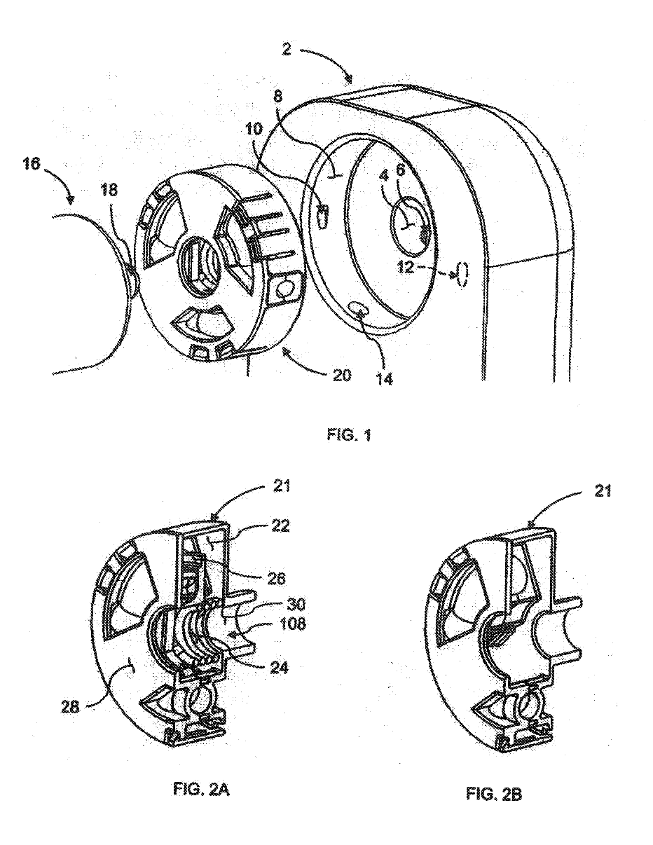

Turning now to the drawings, wherein like numerals refer to like or corresponding parts throughout the several views, the present invention according to a first embodiment (FIGS. 1 through 10) generally comprehends a fluid-actuated controller 20 comprising a stationary housing 21 defining at least one discrete, internal chamber in fluid communication with the stationary housing exterior 50 via an inlet opening, and a rotary actuator 26 mounted in the stationary housing for rotary movement relative thereto. The rotary actuator 26 includes at least one piston 56 for effecting rotary movement of the rotary actuator in a first direction. Optionally, the rotary actuator 26 further includes at least one piston (e.g., 58, 60) for effecting rotary movement of the rotary actuator 26 in a second direction in opposition to the first direction. The piston 56 for effecting rotary movement of the rotary actuator in the first direction is movably disposed in a first internal chamber, and the piston (e.g., 58, 60) for effecting rotary movement of the rotary actuator in the second direction is movably disposed in a second internal chamber. In response to a predefined increase in fluid pressure in the first internal chamber, the piston 56 is movable within the first internal chamber to effect rotary movement of the rotary actuator 26 in the first direction. In response to a predefined increase in fluid pressure in the second internal chamber, the piston (e.g., 58, 60) is movable within the second internal chamber to effect rotary movement of the rotary actuator 26 in the second direction.

The fluid by which rotary movement of the actuator 26 in either of the first or second directions is in operation effected may be any conventional fluid, including, by way of non-limiting example, hydraulic fluid, air, water, oil, etc.

Optionally, the rotary actuator 26 is biased to a default rotational position relative to the stationary housing 21 in the absence of a predefined increase in fluid pressure in any of the one or more internal chambers.

According to the exemplary embodiment, the controller 20 is configured for use in effecting selective rotational movement of the rotary component 16 of a rotary valve, such as may be employed in an the automatic transmission system of a motor vehicle (including, by way of nonlimiting example, the rotary shift valve of US Published Application 2007/0107787, the disclosure of which application is incorporated herein by reference in its entirety). However, it will be understood from this disclosure that the inventive controller has applicability in numerous operational environments requiring a controller for selectively positioning elements that permit energy transfer between each other, including, without limitation, mechanical valve systems, electrical switches, etc.

Referring to FIGS. 6A and 6B, rotary actuator 26 according to the exemplary embodiment includes each of a piston 56 for effecting rotary movement of the rotary actuator in the first direction (clockwise, according to the embodiment of FIG. 6A) and two pistons 58 and 60 for effecting rotary movement of the rotary actuator in the direction (clockwise, according to the embodiment of FIG. 6A). Hereafter, these pistons 56, 58 and 60 are also referred to herein as the primary, secondary and auxiliary pistons, respectively 58. As noted elsewhere, it is contemplated that the rotary actuator 26 may include any combination of pistons for effecting rotary movement of the rotary actuator in the first and, optionally, second directions. Accordingly, it is contemplated that the rotary actuator may be comprised simply of one piston for effecting rotary movement of the rotary actuator in the first direction, or of one piston for effecting rotary movement of the rotary actuator in each of the first and second directions, or of more than one piston for effecting rotary movement of the rotary actuator in either or both of the first and second directions.

Referring still to FIGS. 6A and 6B, the shape of each of the primary 56, auxiliary 60, and secondary 58 pistons is round in cross-section and curved in elevation to correspond to the dimensions of the internal chambers defined in the stationary housing 21.

As shown, each piston 56, 58, 60 comprises a head 62, 64, 66, respectively, which is shaped to closely conform with minimum clearance the cross-sectional dimensions of the internal chambers of the stationary housing 21 in which the pistons are movably disposed. Each piston head 62, 64, 66 has an outwardly facing, flat surface against which fluid may act to effect movement of the rotary actuator in the manner hereafter described. According to the illustrated embodiment, the flat surface of each piston head 62, 64, 66 is defined in a plane that intersects the rotational axis of the rotary actuator 26. However, it will be appreciated that the orientation of these flat surfaces may be altered, such as to modify the force acting to effect rotational movement of the actuator 26.

The primary 56, auxiliary 60, and secondary 58 pistons may have the same or different configurations, subject only to the requirement that each piston 56, 58, 60 be configured for movable disposition in its respective chamber in the stationary housing, all as described hereinafter.

According to the illustrated embodiment, wherein the controller is employed to effect selective rotational movement of the rotary device 16 (FIG. 1), the rotary actuator 26 is provided with means for mechanical interconnection with the rotary device 16. More specifically, there is provided through the rotary actuator 26 a central opening flanked by drive flats 68, 70 to define a cross-sectional shape conforming to the cross-sectional shape of a stem of the rotary device 16. Of course, the design of these mechanical interconnection means may be varied according to the configuration of the driven device.

As noted, the rotary actuator 26 is optionally biased to a default rotational position relative to the stationary housing 22. This biasing may be accomplished by a spring 24 (FIGS. 2 and 5) disposed in a retention pocket 72 defined in the area of the central opening behind drive flats 68, 70 (FIG. 6B). Retention pocket 72 is preferably round to insure the spring 24 is in position during assembly of the controller 20.

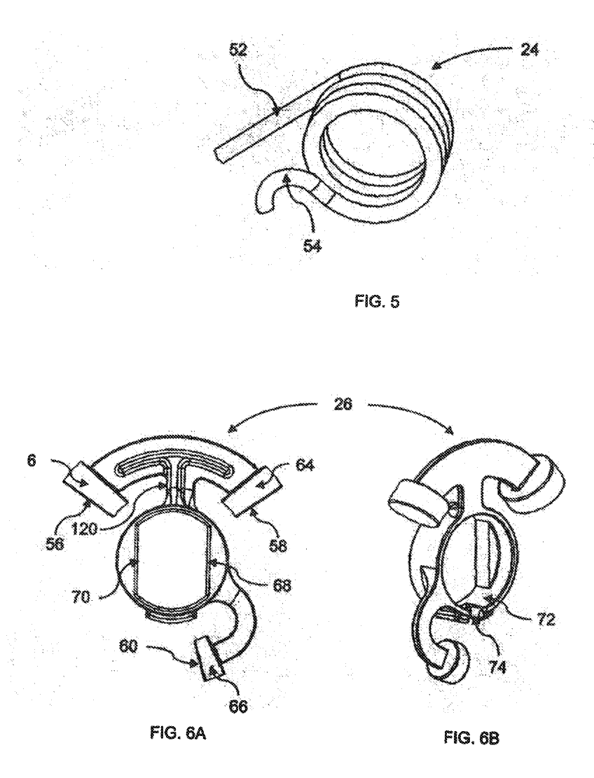

In the illustrated embodiment, the rotary actuator 26 is more particularly biased toward a rotational position in which the auxiliary piston 60 is oriented at the limit of its movement in the second (as depicted, clockwise) direction, which orientation corresponds to a rotational position of the driven rotary device 16 in which the outlet openings therein are 100% aligned with passageways in a downstream housing (not shown). To this end, a return spring 24 is mounted internally to provide a mechanism for return of the rotary actuator 26 to the default position without application of an external load or force, and further to provide a preload to the rotary actuator to increase the required operating force or torque to move the rotary actuator. The spring 24 is characterized as a return spring and, as shown in FIG. 5, may comprise a left-hand torsion spring with a typical straight-end connector 52 and a typical hooked-end connector 54. The return spring hooked-end 54 is connected to the rotary actuator 26 via a slot 74 with curved edges corresponding to the shape of the return spring hooked-end. The straight-end connector 52 is positioned in the space defined in the stationary housing 21 base portion 22 between the semi-circumferential channels 36 and 38 so as to confront the exterior of the wall bounding the channel 38 (FIG. 4).

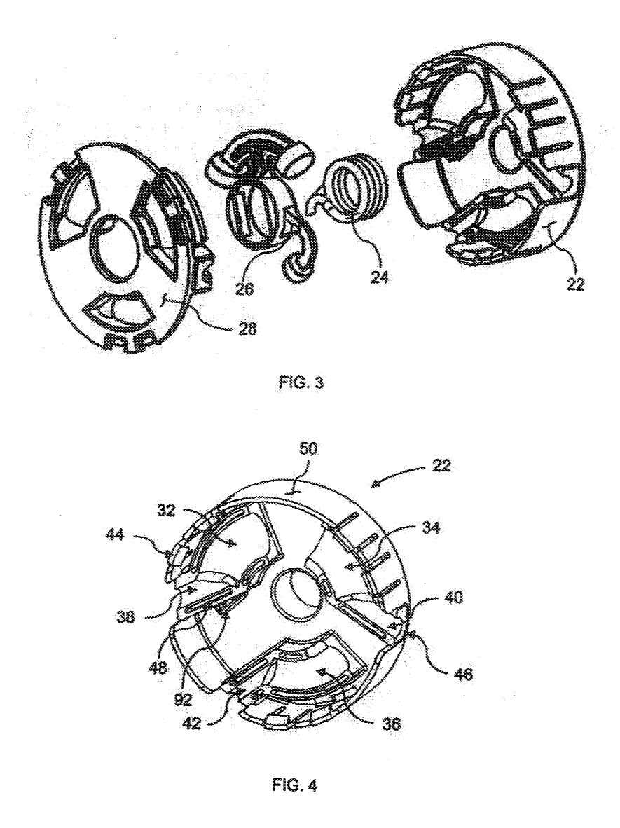

Referring now to FIGS. 3, 4, 7A and 7B, the stationary housing 21 is, in the exemplary embodiment, comprised of two mateable components in the form of a base portion 22 and a cover portion 28.

As best shown in FIG. 4, base portion 22 includes a plurality of interior, semi-circumferential channels 32, 34, 36 each defining a portion of the chambers for pistons 56, 58, 60. Each channel 32, 34, 36 is in fluid communication with the exterior 50 of the housing base portion 22 via one of inlet channels 38, 40, 46, respectively. Each inlet channel 38, 40, 46 is sealed at the exterior surface 50 of the housing via an interface seal half 46.

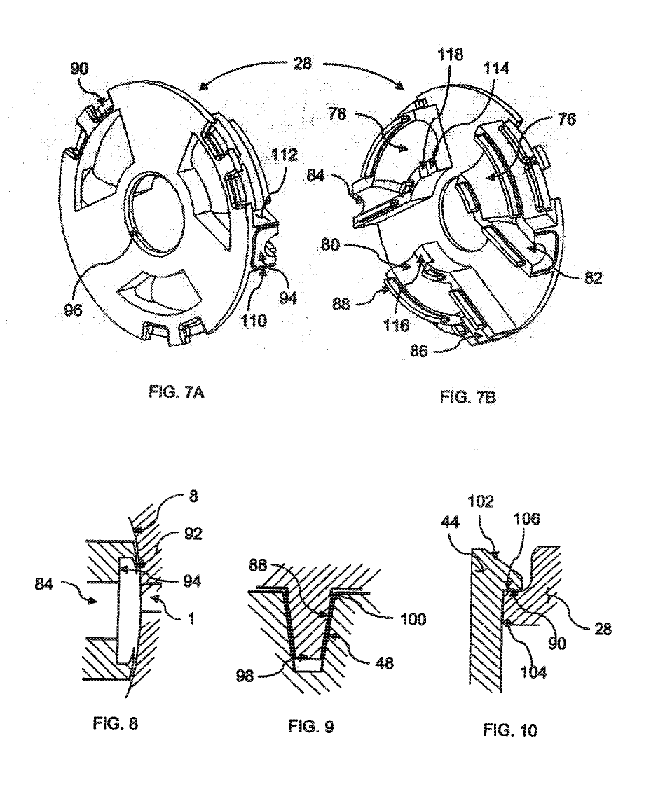

Relatedly, cover portion 28 includes a plurality of similarly configured interior, semi-circumferential channels 76, 78, 80 each defining a portion of the chambers for pistons 56, 58, 60 (FIG. 7B). Each channel 76, 78, 80 is in fluid communication with the exterior 50 of the housing cover portion 28 via one of inlet channels 82, 84, 86, respectively. Each inlet channel 82, 84, 86 is sealed at the exterior surface 50 of the housing via an interface seal half 110.

In the mated condition of base 22 and cover 28 portions, the complementary channels 32, 76 and 34, 78 and 78, 80 together define chambers for each of the primary 56, auxiliary 60 and secondary 58 pistons, while the complementary inlet channels 38, 82 and 40, 84 and 42, 86 together define inlet ports or openings for facilitating fluid communication between the exterior of the stationary housing 21 and the internal chambers. Furthermore, the complementary interface seal halves 46, 94 form a continuous seal around each opening to the inlet openings. Cross-sectional details of each such seal are shown in FIG. 8. When, in operation of the inventive controller, fluid is supplied through an inlet channel into the seal center cavity 94, the interface seal half 110 is pressurized against the bore 8 of support 2 to prevent fluid from leaking (see also FIG. 1).

The channels 32, 76 defining the chamber for primary piston 56 are, according to the illustrated embodiment, largest in diameter to maximize the force (torque) applied to the piston 56. Channels 34, 78 defining the chamber for secondary piston 58, which are smaller in diameter than those defining the chamber for the primary piston 56, can be eliminated if the controller does not require the functionality thereof. The embodiment shown in FIG. 6A does contemplate the provision of a secondary 58 and auxiliary 60 pistons each of which function to counteract the primary piston 56. Channels 36, 80 defining the chamber for the auxiliary piston 60 are, per the illustrated embodiment, characterized by the smallest diameter.

It will be appreciated that the direction of force (torque) applied for any of the pistons 56, 58, 60, etc. (independently or combined) can be reversed according to the particular application in which the controller is employed.

As will be appreciated, the complementary inlet channels 38, 82 and 40, 84 and 42, 86 defining the inlet openings or ports can be adjusted in size and shape to allow any level of fluid flow to the piston channels as needed to control the rate of change in the movement of the rotary drive actuator 26 in the manner hereafter described.

Mating engagement of the stationary housing base 22 and cover 28 portions is accomplished via locking tabs 44 positioned in pairs about the circumference of the base portion, as shown in FIG. 4. Referring also to FIG. 10, each tab 44 is, in mating assembly of the base 22 and cover 28 portions, flexed outwardly by the taper 102 contacting the lip 104 in cover portion 28 to allow receipt of the locking surface 106 of each tab 44 in a corresponding locking recess 90 defined on the cover portion 28 (see also FIGS. 7A and 7B).

Referring next to FIGS. 4, 7A and 7B, base portion 22 includes therein a plurality of retention channels 48 defined in upstanding walls bounding the channels 32, 34, 36, 38, 40, and 42. In mating assembly of the base 22 and cover 28 portions, these retention channels 48 each receive one of a plurality of correspondingly shaped ribs 88 projecting from the cover portion 28. By this arrangement, the piston chambers will remain in alignment and round when internally pressurized. As shown best in FIG. 9, each retention channel 48 and rib 88 have the same angle and act as a wedge with a slight interference when assembled. Optionally, each retention channel 48 may be of sufficient depth to define at the bottom thereof, and below the depth if insertion of the rib 88, a cavity 98 for trapping material that may be extruded during assembly.

Referring again to FIG. 7B, the cover portion 28 includes recesses or cut-out 114, 116 to allow additional travel of the rotary actuator 26. The end of the recess 114 further defines an over-travel mechanical stop 118 for the actuator 26.

The invention as heretofore described may be manufactured from injection-molded thermoplastic (the spring may be steel or other metal) or other suitable polymers, metals, ceramic, sintered metals, etc. Other conventional manufacturing processes for the formation of the inventive controller include metal casting or stamping.

With reference being had to FIGS. 1, 2A and 2B, operation of the inventive controller of FIGS. 1 through 10 may be better understood in respect of an exemplary operational environment, according to which the controller functions to effect the fluid-actuated rotational movement of a rotary device 16, such as a rotary valve for a motor-vehicle automatic transmission system (for instance, by way of non-limiting example, of the type disclosed in US Published Application 2007/0107787).

More particularly, the housing 21 is fixedly disposed in a support 2 through which a fluid is selectively transferred to piston chambers via inlet openings. Still more particularly, fluid transfer from the support 2 to the inlet openings leading to the primary piston chamber is via primary feed channel 10, to the inlet opening leading to the secondary piston chamber is via the secondary feed channel 12, and to the inlet opening leading to the auxiliary piston chamber is via the auxiliary feed channel 14.

The stationary housing 21 is, according to the exemplary embodiment, rigidly fixed to the support, and to this end is dimensioned for an interference fit into the support 2 at the larger diameter 8 opening thereof, and dimensioned to a lesser interference fit of the drive housing pilot 30 into the inner diameter 4 opening.

Stem or center pilot 18 of the rotary device 16 is received through the central opening in the housing 21, the flats of the stem 18 co-acting with the drive flats 68, 70 described above. Fluid is transferred to an internal chamber of the rotary device 16 from the supply port 6 in support 2 through the stem 18. During control of the rotary device 16, the stem 18 rotates relative to the stationary bore 108 in the base portion 22 of housing 21, so the stem 18 and stationary bore 108 are lubricated with pressurized fluid from supply port 6 to minimize friction in the system. Alternatively, an O-ring or other sealing means of conventional construction and design may be employed to minimize leakage and allow greater flexibility in required dimensional control for the interface between the stem 18 and the stationary bore 108.

Selectively and by computer control or other actuation means, a pressurized fluid is supplied from the primary feed channel 10 to the primary piston chamber via the inlet opening thereto in the housing 21. This pressurized fluid acts against the head of primary piston 56, forcing rotary movement of the actuator 26 in a first rotational direction against the bias of return spring 24. Correspondingly, the rotary device 16 is rotated by means of the mechanical interconnection between that device and the controller as heretofore described. By such rotary movement, one or more valve openings (not shown) in the rotary device 16 may be opened, partially or fully, or closed, so that fluid conveyed to the internal chamber of the rotary device 16 may be transferred (or, where the valve openings are closed, prevented from being transferred) through the valve openings.

Rotary movement of the actuator 26 in a second rotational direction opposite of the first direction may be accomplished by arresting the supply of pressurized fluid from the primary feed channel 10 to the primary piston chamber, under which circumstances the return spring 24 would act to return the actuator 26 to its default or biased condition. Alternatively, or in addition, pressurized fluid may be supplied from one or both of the secondary 12 and auxiliary 14 feed channels to the secondary and auxiliary piston chambers via the inlet opening thereto in the housing 21. By these means, the pressurized fluid acts against the heads of secondary 58 and or auxiliary 60 pistons, forcing rotary movement of the actuator 26 in the second rotational direction (and with the bias of return spring 24). Correspondingly, the rotary device 16 is rotated by means of the mechanical interconnection between that device and the controller. Furthermore, rotary motion of the actuator 26 may be effected by a feedback mechanism, according to which the supply of pressurized fluid from one or both of the secondary 12 and auxiliary 14 feed channels to the secondary and auxiliary piston chambers is directly associated with an increase in fluid pressure in the internal chamber of the rotary device 16. As that internal fluid pressure increases, pressurized fluid is conveyed from one or both of the secondary 12 and auxiliary 14 feed channels to the secondary and auxiliary piston chambers to effect the movement of the rotary actuator 26 in the manner previously described.

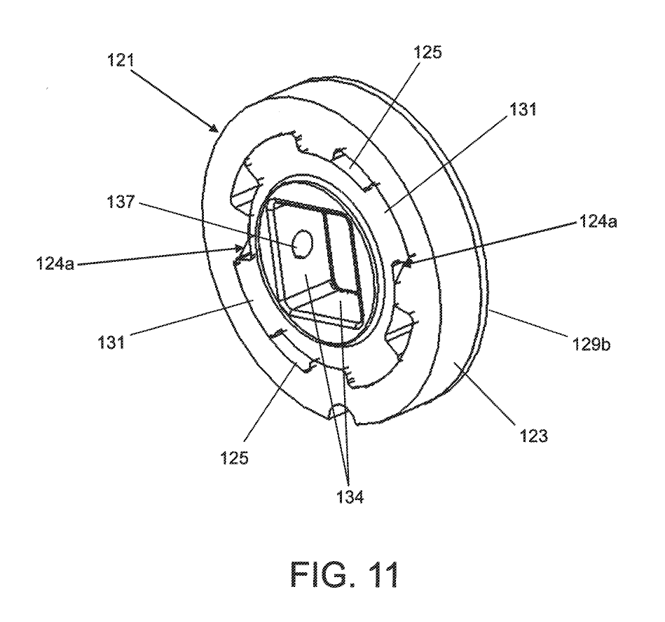

Referring now to FIGS. 11 through 13b, there is shown an alternative embodiment of the present invention, according to which the fluid actuated controller assembly 120 comprises a stationary housing having at least a one discrete internal chamber, each at least one discrete internal chamber being in fluid communication with the stationary housing exterior via an inlet opening; and a rotary actuator mounted in the stationary housing for rotary movement relative thereto, the rotary actuator including at least one piston for effecting rotary movement of the rotary actuator in a first direction, each such piston being movably disposed in a discrete internal chamber, each piston is movable within its associated internal chamber in response to a predefined increase in fluid pressure to effect rotary movement of the rotary actuator in the first direction. The rotary actuator is biased against rotary movement in response to any increase in fluid pressure that is not at least the predefined fluid pressure.

In the illustrated embodiment, the stationary housing is formed of a central portion 121 sandwiched between cover portions 129a (not shown in FIG. 11), 129b, and a rotary actuator 130 rotatably disposed in an internal opening 122 of the central portion 121. As shown, central portion 121 is a generally ring-shaped element the interior (that is, the area bounded by the circumferential wall 123 of the ring) of which defines the internal opening 122. A plurality of spaced-apart projections 124 extend radially inwardly from the circumferential wall 123 to define therebetween a plurality of discrete openings 125, each opening 125 dimensioned to accommodate one of the radially-outwardly extending projections 131 of the rotary actuator 130, as described more fully below.

Cover portion 129a, secured to a first face of central portion 121, defines an opening 126a therethrough dimensioned to receive therein an annular rib or ring 132 projecting upwardly from an opposing surface of the rotary actuator 130. Similarly, cover portion 129b, secured to a second face of central portion 121, defines an opening 126b therethrough dimensioned to receive therein a similar annular rib or ring (not visible) projecting upwardly from an opposing surface of the rotary actuator 130.

Opening in cover portion 129a facilitates access to central opening 133 of the rotary actuator 130 for interconnection between the rotary actuator and the stem of a driven device (e.g., a valve, as described below). As shown, this central opening 133 is square-shaped, being defined by four drive flats 134 to define a cross-sectional shape conforming to the cross-sectional shape of the stem of the driven device. Of course, the shape and other features of this opening may be varied according to the configuration of the driven device.

Cover portions 129a, 129b may be secured to central portion 121 in any conventional manner, such as via adhesives or fasteners, or by locking tabs such as described above in reference to the embodiment of FIGS. 1 through 10. Once the cover portions are so mated to the central portion, the inside (i.e., facing the central portion) surfaces of each cover portion define, in combination with the discrete openings 125 defined by spaced-apart projections 124, a plurality of discrete piston chambers.

In order to fixedly position the fluid-actuated controller assembly 120 of this embodiment relative to a support (not shown), a longitudinal channel may be defined in an exterior surface of the housing by the provision of correspondingly shaped, longitudinally aligned cut-outs 127a, 127b, 127c defined in each of the central portion 121 and cover portions 129a, 129b. This channel is dimensioned to be received over a complementary-shaped projection (not shown) provided on the support (not shown). Of course, other means known to those skilled in the art may be substituted for, or used in conjunction with, the foregoing means, for the same purpose of keeping the housing 121 stationary.

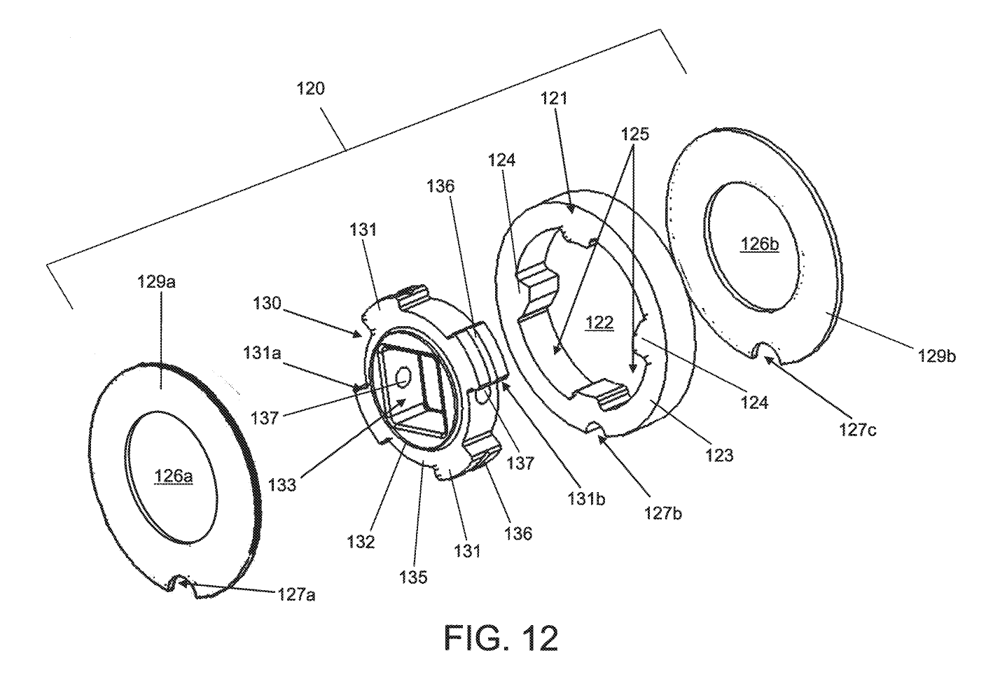

With continuing reference to FIGS. 11 and 12, the rotary actuator 130 will be seen to comprise a ring-like element having a central opening 133 defined interiorly of a circumferential wall 135, and one or more (four are shown in the illustrated embodiment) outwardly radiating projections 131, at least one of which defines a primary piston for effecting rotary movement of the rotary actuator. According to the illustrated embodiment, there are provided two such primary pistons, on opposite projections, the piston heads of which are defined on first sides 131a, 131b of each such projection, as depicted.

Referring particularly to FIG. 12, the circumferential face of each projection 131 will be seen to include a fluid passageway, in the form of channel 136, extending completely between the first face and a second face disposed on a second side of the piston. Each such feed channel 136 communicates a control fluid from one side of each projection 131 to the other side.

With continuing reference to FIG. 12, rotary actuator 130 includes a pair of fluid inlet channels 137 defined through opposing drive flats 134, each fluid inlet channel 137 extending through the circumferential wall 135 of the rotary actuator and terminating in the area defined between adjacent projections. In an operating environment, where the actuator is coupled to a driven device, the driven device communicates a control fluid into each inlet channel 137 via fluid outlet openings in the stem of the driven device (not depicted).

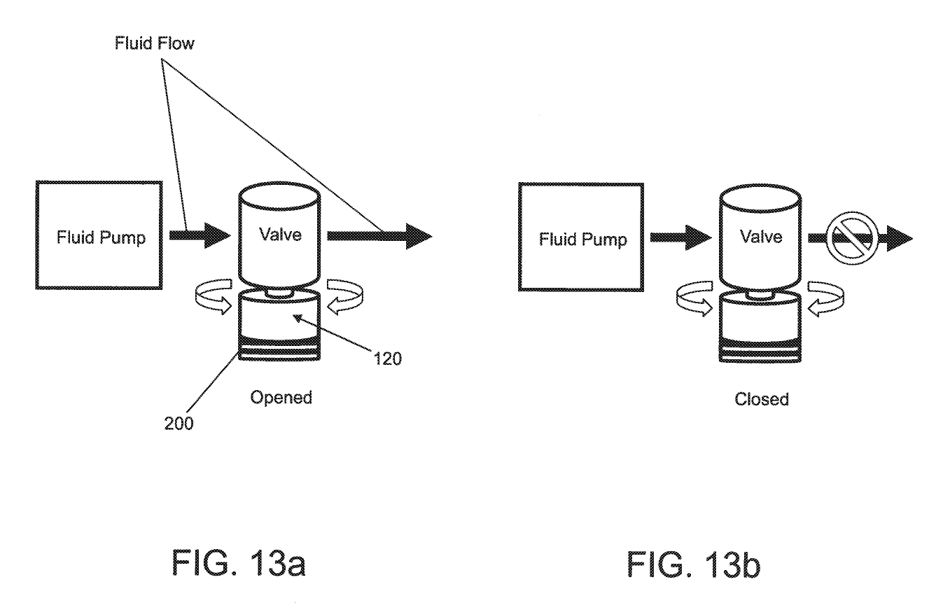

Referring now also to FIGS. 11, 13a and 13b, operation of this alternative embodiment of the present invention may be better understood.

As shown diagrammatically in FIGS. 13a and 13b, the controller assembly of this embodiment has particular utility in the regulation of pressure in an hydraulic system. To this end, the controller assembly 120 is coupled to a driven device in the form of a valve (designated “valve” in FIGS. 13a and 13b) disposed along a fluid path (designated “fluid flow”) defined between an upstream hydraulic pump (designated “pump”) and a downstream destination (not shown). The valve, which is rotatable synchronously with rotary movement of the rotary actuator, between a first, opened position of the valve (FIG. 13a), in which fluid flow is permitted along the fluid path, and a second, closed position of the valve (FIG. 13b), in which that fluid flow is interrupted.

In the first, opened position of the valve, the rotary actuator 130 is positioned within the central portion 121 such that the primary pistons are disposed with piston heads 131a, 131b at rotational extremes (clockwise, according to the illustrated embodiment) within their respective chambers (such as shown in FIG. 11). This condition, the default condition of the rotary actuator 130, is maintained by biasing means, such as a return spring 200 that is connected to each of the controller assembly and a stationary member, such as, for instance, a support for the controller assembly, the stationary housing, etc.

Fluid is supplied to the piston chambers housing each primary piston via the inlet channels 137, being introduced in the space defined immediately adjacent the head of each piston by the angled surface 124a of each projection 124. Upon an increase in the pressure of fluid along the flow path, the pressure of the fluid supplied to the piston chambers correspondingly increases, acting against the heads 131a, 131b of primary pistons to force rotary movement of the actuator 130 in a first rotational direction (counterclockwise, per the illustrated embodiment) against the bias of the return spring. Correspondingly, the driven device (the valve of the illustrated example) is rotated by means of the mechanical interconnection between that device and the controller as heretofore described. By such rotary movement, the valve is moved to the second, closed position thereof (FIG. 13b) in which one or more valve openings (not shown) in the valve are closed, so that fluid is prevented from moving along the flow path downstream of the valve.

As the pressure of the control fluid acting on each primary piston head increases, the fluid is forced through feed channels 136 to the area of the piston chamber on the opposite side of the piston head 131a, 131b. In consequence of the rotational position of the actuator 130 relative to the stationary housing 121, this area of the piston chamber defines a smaller area than the area of the piston chamber proximate the piston head. Control fluid entering this area of the piston chamber resists continued rotary movement of the actuator caused by the force of control fluid acting on the piston heads, thereby reducing the torque applied to the return spring. It also allows the pressure of the control fluid acting on the piston head to rise more slowly, and reduces transient pressures to ensure a more stable hydraulic system.

Upon a decrease in the pressure of the fluid to the point that the pressure of the fluid acting on the piston heads is insufficient to overcome the force (such as via the return spring) biasing the rotary actuator to the default condition thereof, the rotary actuator returns to this default condition. Correspondingly, the driven device (the valve of the illustrated example) is rotated by means of the mechanical interconnection between that device and the controller as heretofore described. By such rotary movement, the valve is returned to the first, opened position thereof (FIG. 13a) in which one or more valve openings (not shown) in the valve are opened, so that fluid is once again permitted to move along the flow path downstream of the valve.

It will be appreciated that, by the design and operation of the fluid-actuated controller as heretofore described in connection with FIGS. 11 through 13b, it is possible to regulate the pressure of a fluid flowing through an hydraulic system by the selection of a spring or other biasing means capable of resisting up to a predetermined force.

By the foregoing, the present invention provides a fluid-actuated controller advantageously combining two or more pistons into an actuator that rotates around a common centerline to apply force or torque independently or in combination in either direction of rotation. As will be appreciated, by the simple expedient of varying the size and/or shape of each piston, the invention provides a controller that can vary the opposed or combined force or torque in any magnitude. Furthermore, the present invention provides a fluid-actuated controller that, by the provision of biasing means (such as, for instance, the exemplified spring) creates an additional force or torque for combination with the force or torque of the one or more of the two or more pistons.

The foregoing description of the exemplary embodiment of the invention has been presented for purposes of illustration and description. It is not intended to be exhaustive of, or to limit the invention to, the precise form disclosed, and modifications and variations thereof are possible in light of the above teachings or may be acquired from practice of the invention. The illustrated embodiment is shown and described in order to explain the principals of the innovation and its practical application so as to enable one skilled in the art to utilize the innovation in this and various additional embodiments and with various modifications as are suited to the particular use contemplated. Although only an exemplary embodiment of the present invention has been described in detail in this disclosure, those skilled in the art who review this disclosure will readily appreciate that many modifications are possible without materially departing from the novel teachings and advantages of the subject matter herein recited. Accordingly, all such modifications are intended to be included within the scope of the present innovations. Other substitutions, modifications, changes and omissions may be made in the design, operating conditions and arrangement of the exemplary embodiment without departing from the spirit of the present invention.

The invention in which an exclusive property or privilege is claimed is defined as follows:

1. A fluid-actuated controller, comprising:
a stationary housing having at least a one discrete internal chamber, each at least one discrete internal chamber being in fluid communication with the stationary housing exterior via an inlet opening;
a rotary actuator mounted in the stationary housing for rotary movement relative thereto, the rotary actuator including at least one piston for effecting rotary movement of the rotary actuator in a first direction, each such piston being movably disposed in a discrete internal chamber; and
wherein each piston is movable within its associated internal chamber in response to a predefined increase in fluid pressure to effect rotary movement of the rotary actuator in the first direction.

2. The fluid-actuated controller of claim 1, further comprising:
at least two discrete internal chambers in the stationary housing, each internal chamber being in fluid communication with the stationary housing exterior via an inlet opening;
the rotary actuator including at least two pistons for effecting rotary movement of the rotary actuator in the first direction, each such piston being movably disposed in a discrete internal chamber; and
wherein each piston is movable within its associated internal chamber in response to a predefined increase in fluid pressure to effect rotary movement of the rotary actuator in the first direction.

3. The fluid-actuated controller of claim 1, further comprising:
at least two discrete internal chambers in the stationary housing, each internal chamber being in fluid communication with the stationary housing exterior via an inlet opening;
the rotary actuator including at least one piston for effecting rotary movement of the rotary actuator in a second direction in opposition to the first direction, each such piston being movably disposed in a discrete internal chamber; and
wherein each piston for effecting rotary movement of the rotary actuator in the second direction is movable within its associated internal chamber in response to a predefined increase in fluid pressure to effect rotary movement of the rotary actuator in the second direction.

4. The fluid-actuated controller of claim 3, further comprising:
at least three discrete internal chambers in the stationary housing, each internal chamber being in fluid communication with the stationary housing exterior via an inlet opening;
the rotary actuator including at least two pistons for effecting rotary movement of the rotary actuator in the second direction, each such piston being movably disposed in a discrete internal chamber; and
wherein each piston for effecting rotary movement of the rotary actuator in the second direction is movable within its associated internal chamber in response to a predefined increase in fluid pressure to effect rotary movement of the rotary actuator in the second direction.

5. The fluid-actuated controller of any of claim 1, wherein the rotary actuator is biased to a default rotational position relative to the stationary housing in the absence of a predefined increase in fluid pressure in any of the one or more internal chambers.

6. The fluid-actuated controller of claim 5, wherein the rotary actuator is spring-biased to the default rotational position relative to the stationary housing.

7. The fluid-actuated controller of any of claim 2, wherein the rotary actuator is biased to a default rotational position relative to the stationary housing in the absence of a predefined increase in fluid pressure in any of the one or more internal chambers.

8. The fluid-actuated controller of claim 7, wherein the rotary actuator is spring-biased to the default rotational position relative to the stationary housing.

9. The fluid-actuated controller of any of claim 3, wherein the rotary actuator is biased to a default rotational position relative to the stationary housing in the absence of a predefined increase in fluid pressure in any of the one or more internal chambers.

10. The fluid-actuated controller of claim 9, wherein the rotary actuator is spring-biased to the default rotational position relative to the stationary housing.

11. The fluid-actuated controller of any of claim 4, wherein the rotary actuator is biased to a default rotational position relative to the stationary housing in the absence of a predefined increase in fluid pressure in any of the one or more internal chambers.

12. The fluid-actuated controller of claim 11, wherein the rotary actuator is spring-biased to the default rotational position relative to the stationary housing.

13. A fluid-actuated controller, comprising:
a stationary housing having at least a one discrete internal chamber, each at least one discrete internal chamber being in fluid communication with the stationary housing exterior via an inlet opening;
a rotary actuator mounted in the stationary housing for rotary movement relative thereto, the rotary actuator including at least one piston for effecting rotary movement of the rotary actuator in a first direction, each such piston being movably disposed in a discrete internal chamber;
wherein each piston is movable within its associated internal chamber in response to a predefined increase in fluid pressure to effect rotary movement of the rotary actuator in the first direction; and
wherein the rotary actuator is biased against rotary movement in response to any increase in fluid pressure which is not at least the predefined fluid pressure.

14. The fluid-actuated controller of claim 13, wherein the rotary actuator is biased against rotary movement by a spring.

15. The fluid-actuated controller of claim 13, further comprising a valve rotatably coupled to the rotary actuator, the valve being rotatable synchronously with the rotary actuator between a first, opened position of the valve, and a second, closed position of the valve, and wherein the valve is moved to the closed position in response to the predefined increase in fluid pressure effecting rotary movement of the rotary actuator, and to the opened position in response to a decrease in fluid pressure from level of the predefined increase.

16. The fluid-actuated controller of claim 15, wherein the rotary actuator is biased against rotary movement by a spring.

17. The fluid-actuated controller of claim 13, wherein each at least one piston includes a piston face disposed on a first side of the piston which is acted upon by the fluid to effect rotary movement of the rotary actuator, and a second face disposed on a second side of the piston, and wherein further at least one of the at least one pistons is provided with a fluid passageway for communicating fluid from the first side of the piston to the second side of the piston.
